(19) United States
(12) Patent Application Publication
(10) Pub. No.: US 2026/0201508 A1
(43) Pub. Date: Jul. 16, 2026

(54) ALUMINIUM-BASED ALLOY AND ITEM MADE OF SAME

(71) Applicant: OBSHCHESTVO S OGRANICHENNOJ OTVETSTVENNOST'YU "INSTITUT LEGKIKH MATERIALOV I TEKHNOLOGIJ", Moscow (RU)

(72) Inventors: Viktor Khrist'yanovich MANN, Krasnoyarsk (RU); Aleksandr Yur'evich KROKHIN, Krasnoyarsk (RU); Dmitrij Konstantinovich RYABOV, Krasnoyarsk (RU); Roman Olegovich VAKHROMOV, Krasnoyarsk (RU); Aleksandr Yur'evich GRADOBOEV, Krasnoyarsk (RU); Ruslan Tejmurovich ALIEV, Krasnoyarsk (RU)

(21) Appl. No.: 19/137,121

(22) PCT Filed: Oct. 20, 2023
(86) PCT No.: PCT/RU2023/050247

§ 371 Date: Jun. 9, 2025

(30) Foreign Application Priority Data
Dec. 26, 2022 (RU) 2022134225

(51) Int. Cl. C22C 21/00; C22F 1/04; H01B 1/02

(52) U.S. Cl. CPC C22C 21/00; C22F 1/04; H01B 1/023

(57) ABSTRACT

The invention refers to the metallurgy, in particular to non-heat-treatable electrical-grade aluminium alloys. The alloy contains, % wt: Fe up to 0.2, Si up to 0.08, Zr 0.05-0.11, Sc 0.01-0.03, Er and Yb in total or separately 0.02-0.15, inevitable impurities each not more than 0.01 and in total not more than 0.05 including V, Ti, Mn, Cr in total not more than 0.02, aluminium not less than 99.5. It structurally has nanodispersed precipitates with L1₂ crystalline structure of Al₃Sc and Al₃Zr phases, as well as Al₃(Sc,Zr) and Al₃(Sc,Zr,Er,Yb) multicomponent phases. The alloy also may contain Ce and Y in total or separately 0.05-0.3% wt. The alloy has high mechanical properties and high electrical conduction not less than 60% IACS.

### TECHNICAL AREA

The invention refers to the non-ferrous metallurgy, in particular to non-heat-treatable electrical-grade aluminium alloys, and it can be used for manufacturing of electrically conductive busbars, electrically conductive wire rod, electrical wiring, and other electrical products.

### TECHNICAL LEVEL

Aluminium is widely used for manufacturing of electrical products, electrical wires, cables, electrically conductive busbars. Aluminium has lower electrical conductivity as compared to copper. It is also lighter by 3 times than copper and significantly cheaper.

The most commonly used aluminium alloys for manufacturing of busbars and electrical wiring are standardised Russian grades A5E and A7E (GOST 15176-89), as well as their foreign equivalents AA1350 and AA1370 (ASTM B236), where aluminium contents are not less than 99.5% wt and 99.7% wt respectively, while impurities of elements, such as Ti, Cr, Mg, V, able to significantly reduce electrical conduction even in very small additives, are limited by their total content at 0.01-0.02% wt.

Electrical conduction of these aluminium grades is high at 61-62% IACS (International Annealed Copper Standard); however, products made of them do not have high strength properties. Ultimate tensile strength for products in the annealed state is at 70-80 MPa. When using products in the mounded state, for example, electrically conductive busbars made of cold-rolled sheets, ultimate tensile strength increases up to 100-120 MPa, but heating including local heating over 150-200° C. results at that in softening of the material to the annealed state.

There are also known electrically conducting aluminium alloys of the Al—Mg—Si type, such as grade AD31E (GOST 4784) or grade 6061 (ASTM B317), which have significantly higher strength up to 190 MPa in the quenched and artificially aged state, but their electrical conduction is lower at that and it is at 53-56% IACS. Furthermore, the need for quenching and ageing of finished products may impose a restriction on workability and increase production costs.

There are known methods to increase mechanical properties of electrical grade aluminium without reduction of electrical conduction through doping with scandium, zirconium, and other rare-earth metals.

There is a known patent of Northwestern University and NanoAl LLC (U.S. Pat. No. 9,453,272 published on Sep. 27, 2016), which describes a thermally stable electrically conductive alloy doped with Zr from 0.1% (0.03% at) to 1.0% (0.3% at), as well as with Er 0.25% (0.04% at), Sn 0.43% (0.1% at), and In 0.42% (0.1% at). Hardening and thermal stabilisation are achieved in this solution thanks to nanodispersed hardening precipitates of Al₃Zr and Al₃(Er,Zr) phase particles with L1₂ structure. A disadvantage of this solution is its insufficient electrical conduction at 59.3-59.8% IACS.

Also, there is a patent of the National University of Science & Technology MISIS (RU2446222 published on Mar. 27, 2012), which describes a heat-resistant aluminium-based alloy doped in combination with Zr from 0.2% wt to 0.64% wt and Sc from 0.01% wt to 0.12% wt, as well as with other elements: Cu up to 1.9% wt, Mn up to 1.8% wt, Fe up to 0.4% wt, Si 0.15% wt, and Al as balance. A disadvantage of this alloy is its insufficient electrical conduction at 53% IACS.

The closest equivalent solution chosen as a prototype is that under patent #RU2556179 published on Jul. 10, 2015, namely: a heat-resistant electrically conducting aluminium-based alloy (options) and a method for production of wrought semi-finished products from the aluminium-based alloy, whereby the patent describes the aluminium alloy doped in combination with Sc and Zr, as well as with other elements, containing the following components, % wt:

| | |
|---|---|
| Zr | 0.1-0.5 |
| Sc | 0.02-0.15 |
| Fe | 0.01-0.3 |
| Si | 0.01-0.15 |
| Cu | 0.5-0.85 |
| Mn | 0.5-0.95 |
| B | 0.02-0.15 |
| Al | Balance |

Application of Sc and Zr in this alloy provides high mechanical properties and heat resistance thanks to precipitation of Al₃(Zr,Sc) phase nanoparticles with average size not more than 20 nm and L1₂ structure. A disadvantage of this alloy is high content of Cu, Mn, and Si. As a result of this, annealing at 250° C. with soaking for 400 h allows achieving the maximum electrical conduction value of 57% IACS (with tensile strength at 170 MPa), which is lower than that of electrically conductive aluminium grades.

### Invention Disclosure

The problem and technical result of this invention are to increase mechanical properties of electrically conductive aluminium grades from 80 to 150-170 MPa with electrical conduction not lower than 60% IACS.

The problem is solved and the technical result is achieved by means of combined doping of the wrought aluminium alloy with Sc from 0.01% wt to 0.03% wt and Zr from 0.07% wt to 0.11% wt, as well as with Er and Yb in total quantity from 0.02% wt to 0.15% wt, which in turn ensures nanodispersed hardening of the aluminium matrix with particles of Al₃Sc, Al₃Zr, Al₃(Sc,Zr) and Al₃(Sc,Er,Yb,Zr) phases, and also by means of additional doping with Ce and Y in total quantity from 0.05% wt to 0.3% wt, which allows improving heat resistance of products.

### BRIEF DESCRIPTION OF DRAWINGS

FIG. 1 gives microstructure of the alloy with precipitation of Al₃(Sc,Zr) and Al₃(Sc,Zr,Er,Yb) nanodispersoids got using a transmission electron microscope.

FIG. 2 gives graphs of changes in mechanical properties (tensile strength, yield strength, percentage elongation) of cold-rolled sheets with various compositions depending on annealing temperature.

FIG. 3 gives microstructure of cold-rolled sheets made of the alloy doped with Sc, Zr, Er, Yb, namely: Al+0.3% Sc+0.8% Zr+0.14% Er,Yb+0.3% Ce, Y before and after annealing operations.

### INVENTION EMBODIMENT

Iron and silicon are inevitable impurities during production of primary aluminium.

Silicon in aluminium of electrical grades A5E, A7E is considered as a harmful impurity, which reduces electrical conduction, and its content is limited to 0.08-0.10% wt.

As distinct from silicon, iron is scarcely dissolved in aluminium and its low concentrations do not significantly reduce electrical conduction. There are known series 8xxx low-alloyed aluminium alloys of grades 8030 and 8176 designed for application in cable/conductor products, which contain small additives of iron at 0.5% wt on average. Taking into account the initial iron content in primary aluminium at 0.1-0.2% wt, there is no economic feasibility to limit its content to less than 0.2% wt and use a better purified (and more expensive) material.

Zirconium additives are applied to increase strength and heat resistance of aluminium wires. The maximum solubility of Zr in aluminium is 0.28% wt at 660.8° C. Positive effects from zirconium on heat resistance and mechanical properties are driven by formation of nanodispersed precipitates of Al₃Zr metastable phase with average size not more than 10 nm, which are formed in the material during annealing at temperatures about 450° C. and which also allow increasing the recrystallisation start temperature in addition to hardening of the alloy. Higher annealing temperature results in formation of sufficiently coarse stable phases with D0₂₃ incoherent structure and significant reduction of the hardening effect. There is a known electrically conductive wire rod grade made of an alloy with addition of Zr about 0.2% wt and produced in continuous casting/rolling units, which has high mechanical properties, heat resistance, and sufficient electrical conduction not less than 60% IACS. Application of such zirconium concentrations necessitates heat treatment for maximum precipitation of hardening nanodispersed particles and increase of electrical conduction to the required level through dilution of solid solution for about 100-150 h, which may impose restrictions on the process production capacity in commercial production. Application of high-melting zirconium in concentrations up to 0.2% wt also necessitates application of high temperatures during melting and casting at 850-900° C., which may be complicated in semi-continuous casting equipment used in the industry.

In consideration of the foregoing, it is advisable to dope the alloy with zirconium at not more than 0.11% wt.

One of the most efficient alloying elements, small additives of which increase mechanical properties, is Sc (with maximum solubility in aluminium of 0.38% wt at 660° C.). Just like zirconium, scandium in aluminium forms Al₃Sc coherent nanodispersed phase with L1₂ structure. Temperature of Sc precipitation from solid solution is in the range of 300-400° C. and the process itself takes place significantly faster at concentrations up to 0.1% wt. Combined doping with zirconium and scandium results in formation of Al₃(Zr,Sc) two-component nanodispersed precipitates. Despite high hardening efficiency of aluminium alloys doped with scandium, addition of scandium at more than 0.05% wt is restricted by a very high cost of this element and master alloys based on it.

High hardening efficiency of aluminium alloys doped with scandium is restricted by a very high cost of scandium itself. Elements applied during manufacturing of electrically conductive aluminium alloys are Ce (cerium) and Y (yttrium). Sc and Ce have similar contents in the Earth crust, but their cost and consumption differ by three-four orders. Doping of aluminium alloys with Ce allows producing alloys with improved high-temperature properties. Similar to scandium, Y forms intermetallic compounds with aluminium. Addition of Y eliminates segregation of dendrites in the as-cast state, promotes formation of equiaxial grains, and increases precipitation of Fe and Si atoms from solid solution resulting in higher electrical conduction. Addition of Y at 0.1% wt also decreases density of defects (dislocations, packaging defects, and subgrain boundaries), which are formed upon deformation processing (drawing), and increases electrical conduction.

Other rare-earth elements able to increase strength properties without significant reduction of electrical conduction are Er (erbium) and Yb (ytterbium). Similar to Sc, both elements form in aluminium Al₃(Er, Yb) metastable phase with L12 cubic lattice. Addition of Er and Yb to alloys doped with Sc and Zr results in Al₃(Sc_{0.56}Yb_{0.14}Er_{0.10}Zr_{0.20}) multicomponent nanodispersed precipitates of lesser size with radius up to 3.5 nm after proper selection of heat treatment modes, i.e. this allows achieving more dispersed structure as compared to similar alloys doped only with Zr and Sc. At that, Yb and Er are concentrated at the centre of dispersoids, whereas the shell is enriched with Sc and Zr. Addition of Er and Yb also notably increases fatigue properties of low alloys with Sc and Zr, which is important for products applicable in the automotive industry and exposed to long-term cyclic loads.

Taking into account the initial contents of iron, silicon, and impurities, doping with scandium and zirconium, as well as need for keeping aluminium content not less than 99.5% wt in order to achieve high electrical conduction of the alloy at 60% IACS, the total content of Er and Yb additives is limited to 0.15% wt.

### Invention Embodiment Examples

Some slabs of various compositions based on grade AA1350 aluminium doped with Sc, Zr, as well as with Er, Yb and Ce, Y, were cast under pilot conditions with the semi-continuous method. Their compositions are given in Table 1.

TABLE 1
Chemical composition of slabs

| | Elements, % wt | | | | | | | | | | |
|---|---|---|---|---|---|---|---|---|---|---|---|
| | | | Cr + Mn + | | | | | | | Impurities, | |
| Composition # | Si | Fe | Ti + V | Sc | Zr | Er | Yb | Ce | Y | total max | Al |
| 1 | 0.07 ± | 0.18 ± | Max | 0.03 ± | 0.08 ± | 0.02 ± | 0.02 ± | — | — | 0.05 | Base |
| | 0.01 | 0.02 | 0.01 | 0.005 | 0.01 | 0.002 | 0.002 | | | | |
| 2 | 0.07 ± | 0.18 ± | Max | 0.01 ± | 0.05 ± | 0.07 ± | 0.07 ± | — | — | 0.05 | Base |
| | 0.01 | 0.02 | 0.01 | 0.005 | 0.01 | 0.002 | 0.002 | | | | |
| 3 | 0.07 ± | 0.18 ± | Max | 0.03 ± | 0.09 ± | 0.07 ± | 0.07 ± | — | — | 0.05 | Base |
| | 0.01 | 0.02 | 0.01 | 0.005 | 0.01 | 0.002 | 0.002 | | | | |
| 4 | 0.07 ± | 0.18 ± | Max | 0.01 ± | 0.05 ± | 0.02 ± | 0.02 ± | 0.02 ± | 0.05 ± | 0.05 | Base |
| | 0.01 | 0.02 | 0.01 | 0.005 | 0.01 | 0.002 | 0.002 | 0.005 | 0.01 | | |
| 5 | 0.07 ± | 0.18 ± | Max | 0.03 ± | 0.09 ± | 0.07 ± | 0.07 ± | 0.05 ± | 0.05 ± | 0.05 | Base |
| | 0.01 | 0.02 | 0.01 | 0.005 | 0.01 | 0.002 | 0.002 | 0.005 | 0.01 | | |
| 6 | 0.07 ± | 0.18 ± | Max | 0.03 ± | 0.09 ± | 0.07 ± | 0.07 ± | 0.1 ± | 0.2 ± | 0.05 | Base |
| | 0.01 | 0.02 | 0.01 | 0.005 | 0.01 | 0.002 | 0.002 | 0.005 | 0.01 | | |

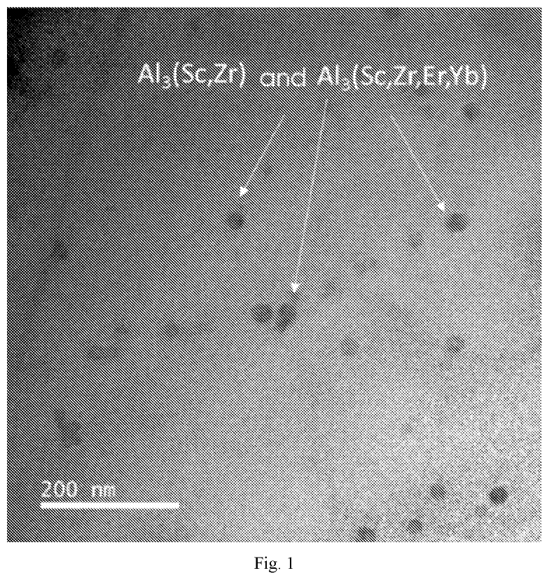

The slabs were exposed to special heat treatment for structural formation of hardening nanodispersed precipitates with L1₂ crystalline structure of Al₃Sc, Al₃Zr, and Al₃(Sc,Zr,Er,Yb) phases (FIG. 1).

The heat-treated slabs were hot rolled in a pilot rolling mill to sheets 10 mm thick. Then, they were cold rolled to sheets up to 3 mm thick. Mechanical properties of the cold-rolled sheets are given in Table 2.

TABLE 2
Mechanical properties of the cold-rolled sheets

| | Ultimate | | |
|---|---|---|---|
| | tensile | Yield | |
| Composition | strength, | strength, | Percentage |
| # | MPa | MPa | elongation, % |
| 1 | 172 | 167 | 11 |
| 2 | 175 | 168 | 11 |
| 3 | 186 | 178 | 10 |
| 4 | 180 | 170 | 11 |
| 5 | 182 | 172 | 10 |
| 6 | 185 | 175 | 10 |

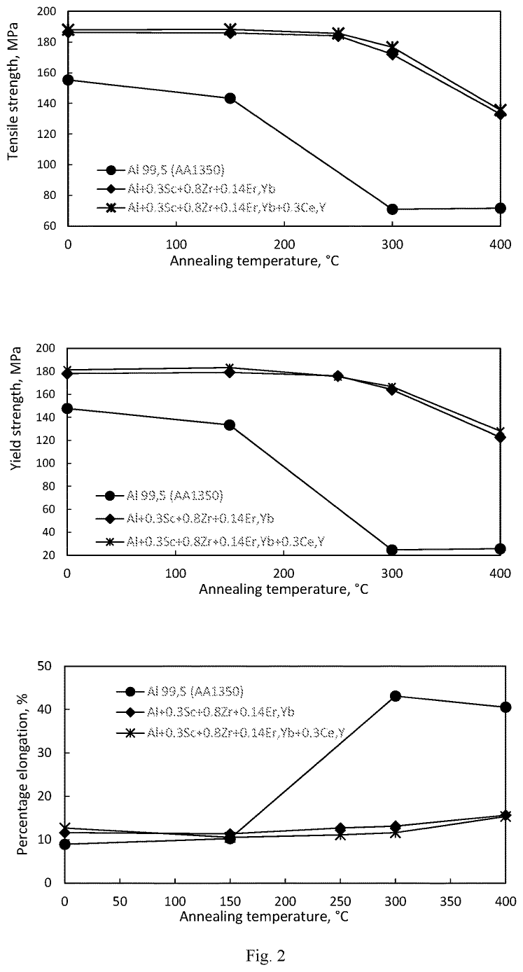

The cold-rolled sheets were heat treated at temperatures from 150° C. to 400° C. with soaking time up to 3 h. The dependency of mechanical properties of the sheets on temperature is given in FIG. 2.

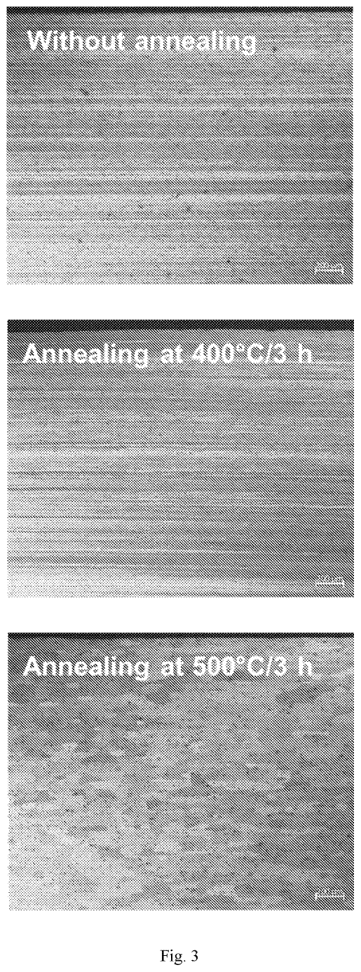

Alloys doped with Sc and Zr, as well as additionally doped with Er, Yb and Ce, Y, have significantly higher strength as compared to similarly produced sheets of grade AA1350. A distinctive feature of these alloys is absence of significant softening upon heat treatment up to 300° C. and absence of structure recrystallisation upon heat treatment up to 400° C. (FIG. 3).

The sheets after stabilising annealing at temperature of 150° C. have the best combination of strength, plasticity, and electrical conduction. Their properties are given in Table 3.

TABLE 3
Mechanical properties and electrical conduction
of the sheets after stabilising annealing

| | Ultimate | | | |
|---|---|---|---|---|
| | tensile | Yield | | Electrical |
| Composition | strength, | strength, | Percentage | conduction, |
| # | MPa | MPa | elongation, % | IACS % |
| 1 | 170 | 162 | 12.1 | 60.3 |
| 2 | 173 | 163 | 13.2 | 60.5 |
| 3 | 184 | 173 | 12.1 | 60.2 |
| 4 | 178 | 165 | 13.2 | 60.3 |
| 5 | 180 | 167 | 13.2 | 60.1 |
| 6 | 183 | 170 | 13.2 | 60.1 |

Elemental composition of the offered alloy subject to control of inevitable impurities including V, Ti, Mn, Cr ensures the necessary alloy structure and properties for achievement of the technical result.

Taking into consideration the above description and examples, the scope of legal protection is solicited for the offered electrical-grade aluminium alloy containing iron, silicon, zirconium, scandium, and at least one element from the group of Er and Yb, with the following ratio of components, % wt:

| | |
|---|---|
| Fe | Up to 0.2 |
| Si | Up to 0.08 |
| Zr | 0.05-0.11 |
| Sc | 0.01-0.03 |
| Er and/or Yb | In total or separately 0.02-0.15 |
| Inevitable impurities | Each not more than 0.01, in total not more |
| | than 0.05 |
| Including V, Ti, Mn, Cr | In total not more than 0.02 |
| Aluminium | Not less than 99.5 |

This alloy structurally has nanodispersed precipitates with L1₂ crystalline structure of Al₃Sc and Al₃Zr phases, as well as Al₃(Sc,Zr) and Al₃(Sc,Zr,Er,Yb) multicomponent phases.

Another offered electrical-grade aluminium alloy contains iron, silicon, zirconium, scandium, and at least one element from the group of Er and Y, as well as at least one element from the group of Ce and Y, with the following ratio of components, % wt:

| | |
|---|---|
| Fe | Up to 0.2 |
| Si | Up to 0.08 |
| Zr | 0.07-0.11 |
| Sc | 0.01-0.03 |
| Er and/or Yb | In total or separately 0.02-0.15 |
| Ce and/or Y | In total or separately 0.05-0.3 |
| Inevitable impurities | Each not more than 0.01, in total not more |
| | than 0.05 |
| Including V, Ti, Mn, Cr | In total not more than 0.02 |
| Aluminium | Not less than 99.5 |

This alloy also structurally has nanodispersed precipitates with L1₂ crystalline structure of Al₃Sc and Al₃Zr phases, as well as Al₃(Sc,Zr) and Al₃(Sc,Zr,Er,Yb) multicomponent phases.

A metallic product can be manufactured in form of an electrically conductive busbar. At that, it is made of the aluminium alloy in any option and it has electrical conduction not less than 60% IACS.

A metallic product can be manufactured in form of an electrically conductive wire rod, bar, or wire. At that, it is made of the aluminium alloy in any option and it has electrical conduction not less than 60% IACS.

A metallic product can be manufactured in form of a rolled or extruded product made of the electrical-grade aluminium alloy. At that, it is made of the aluminium alloy in any option and it has electrical conduction not less than 60% IACS.

1. Electrical-grade aluminium alloy containing iron, silicon, zirconium, scandium, and at least one element from the group of Er and Yb, with the following ratio of components, % wt:

| | |
|---|---|
| Fe | Up to 0.2 |
| Si | Up to 0.08 |
| Zr | 0.05-0.11 |
| Sc | 0.01-0.03 |
| Er and/or Yb | In total or separately 0.02-0.15 |
| Inevitable impurities | Each not more than 0.01, in total not more |
| | than 0.05 |
| Including V, Ti, Mn, Cr | In total not more than 0.02 |
| Aluminium | Not less than 99.5 |

2. The aluminium alloy of claim 1 characterised in that it structurally has nanodispersed precipitates with L1₂ crystalline structure of Al₃Sc and Al₃Zr phases, as well as Al₃(Sc,Zr) and Al₃(Sc,Zr,Er,Yb) multicomponent phases.

3. Electrical-grade aluminium alloy containing iron, silicon, zirconium, scandium, and at least one element from the group of Er and Y, as well as at least one element from the group of Ce and Y, with the following ratio of components, % wt:

| | |
|---|---|
| Fe | Up to 0.2 |
| Si | Up to 0.08 |
| Zr | 0.07-0.11 |
| Sc | 0.01-0.03 |
| Er and/or Yb | In total or separately 0.02-0.15 |
| Ce and/or Y | In total or separately 0.05-0.3 |
| Inevitable impurities | Each not more than 0.01, in total not more |
| | than 0.05 |
| Including V, Ti, Mn, Cr | In total not more than 0.02 |
| Aluminium | Not less than 99.5 |

4. The aluminium alloy of claim 3 characterised in that it structurally has nanodispersed precipitates with L1₂ crystalline structure of Al₃Sc and Al₃Zr phases, as well as Al₃(Sc,Zr) and Al₃(Sc,Zr,Er,Yb) multicomponent phases.

5. Metallic product manufactured in form of an electrically conductive busbar characterised in that it is made of the aluminium alloy of claim 1 and it has electrical conduction not less than 60% IACS.

6. Metallic product manufactured in form of an electrically conductive wire rod, bar, or wire characterised in that it is made of the aluminium alloy of claim 1 and it has electrical conduction not less than 60% IACS.

7. Metallic product manufactured in form of a rolled or extruded product made of the electrical-grade aluminium alloy characterised in that it is made of the aluminium alloy of claim 1 and it has electrical conduction not less than 60% IACS.

8. Metallic product manufactured in form of an electrically conductive busbar characterised in that it is made of the aluminium alloy of claim 2 and it has electrical conduction not less than 60% IACS.

9. Metallic product manufactured in form of an electrically conductive wire rod, bar, or wire characterised in that it is made of the aluminium alloy of claim 2 and it has electrical conduction not less than 60% IACS.

10. Metallic product manufactured in form of a rolled or extruded product made of the electrical-grade aluminium alloy characterised in that it is made of the aluminium alloy of claim 2 and it has electrical conduction not less than 60% IACS.

11. Metallic product manufactured in form of an electrically conductive busbar characterised in that it is made of the aluminium alloy of claim 3 and it has electrical conduction not less than 60% IACS.

12. Metallic product manufactured in form of an electrically conductive wire rod, bar, or wire characterised in that it is made of the aluminium alloy of claim 3 and it has electrical conduction not less than 60% IACS.

13. Metallic product manufactured in form of a rolled or extruded product made of the electrical-grade aluminium alloy characterised in that it is made of the aluminium alloy of claim 3 and it has electrical conduction not less than 60% IACS.

14. Metallic product manufactured in form of an electrically conductive busbar characterised in that it is made of the aluminium alloy of claim 4 and it has electrical conduction not less than 60% IACS.

15. Metallic product manufactured in form of an electrically conductive wire rod, bar, or wire characterised in that it is made of the aluminium alloy of claim 4 and it has electrical conduction not less than 60% IACS.

16. Metallic product manufactured in form of a rolled or extruded product made of the electrical-grade aluminium alloy characterised in that it is made of the aluminium alloy of claim 4 and it has electrical conduction not less than 60% IACS.
